(19) United States
(12) Patent Application Publication
(10) Pub. No.: US 2026/0077821 A1
(43) Pub. Date: Mar. 19, 2026

(54) STRUCTURAL COMPONENTS FOR A VEHICLE AND METHODS

(71) Applicant: AUTOTECH ENGINEERING S.I., Amorebieta-Etxano (ES)

(72) Inventors: Jordi CASTILLA MORENO, Hospitalet de Llobregat, Barcelona (ES); Manuel LÓPEZ LAGE, Abrera, Barcelona (ES); Marti MECA MARTINEZ, Santpedor, Barcelona (ES); Sergi MARQUEZ DURAN, Rajadell, Barcelona (ES)

(21) Appl. No.: 19/109,132

(22) PCT Filed: Sep. 21, 2023
(86) PCT No.: PCT/EP2023/076069

§ 371 Date: Mar. 6, 2025

(30) Foreign Application Priority Data
Sep. 22, 2022 (EP) 22382876.5

(51) Int. Cl. B62D 29/00; B21D 22/20; B62D 25/08; C21D 1/673

(52) U.S. Cl. CPC B62D 29/007; B21D 22/208; B62D 25/08; C21D 1/673

(57) ABSTRACT

The present disclosure relates to structural components for a vehicle framework at least partially configured for supporting compressive loads. A structural component comprises a main member extending from a load receiving end to an opposite end along a longitudinal direction. Further, the main member comprises a main soft zone having lower mechanical properties than other zones of the main member. Further, the main soft zone comprises a first portion and a second portion with substantially constant first and second mechanical properties respectively. The mechanical properties of the first portion are lower than the mechanical properties of the second portion.

The present application claims the benefit of EP22382876.5 filed on Sep. 22, 2022.

The present disclosure relates to structural components for a vehicle framework, the structural components being at least partially configured for supporting compressive loads.

### BACKGROUND

Vehicles such as cars incorporate a structural skeleton designed to withstand the loads that the vehicle may be subjected to during its lifetime. The structural skeleton is further designed to withstand and absorb impacts, in case of e.g. collisions with other cars or road structures.

The demand for weight reduction in the automotive industry has led to the development and implementation of lightweight materials or components, and related manufacturing processes and tools. The demand for weight reduction is especially driven by the goal of a reduction of CO₂ emissions. The growing concern for occupant safety also leads to the adoption of materials which improve the integrity of the vehicle during a crash while also improving the energy absorption.

A process known as Hot Forming Die Quenching (HFDQ) typically uses boron steel sheets to create stamped components with Ultra High Strength Steel (UHSS) properties, with tensile strengths of e.g. 1.500 MPa or 2.000 MPa or even more. The increase in strength allows for a thinner gauge material to be used, which results in weight savings over conventionally cold stamped mild steel components. Throughout the present disclosure UHSS may be regarded as a steel having an ultimate tensile strength of 1.000 MPa or more after a press hardening process.

In a HFDQ process, a blank to be hot formed may be heated to a predetermined temperature e.g. austenization temperature or higher (and particularly between Ac3 and an evaporation temperature of e.g. a coating of the blank). A furnace system may be used for this purpose. Depending on the specific needs, a furnace system may be complemented with additional heaters, e.g. induction or infrared. By heating the blank, the strength of the blank decreases and deformability increases i.e. to facilitate the hot stamping process.

There are several known Ultra High Strength steels (UHSS) for hot stamping and hardening. The blank may be made e.g. of a boron steel, coated or uncoated, such as Usibor® (22MnB5) commercially available from ArcelorMittal.

Hot Forming Die Quenching may also be called “press hardening” or “hot stamping”. These terms will be used interchangeably throughout the present disclosure.

Typical vehicle components that may be manufactured using the HFDQ process include: door beams, bumper beams, cross/side members, A/B pillar reinforcements, front and rear rails, seat crossmembers and roof rails.

Hot forming of boron steels is becoming increasingly popular in the automotive industry due to their excellent strength and formability. Many structural components that were traditionally cold formed from mild steel are thus being replaced with hot formed equivalents that offer a significant increase in strength. This allows for reductions in material thickness (and thus weight) while maintaining the same strength. However, hot formed components offer very low levels of ductility and energy absorption in the as-formed condition.

In order to improve the ductility and energy absorption in specific areas of a component, it is known to introduce softer regions within the same component. This improves ductility locally while maintaining the required high strength overall. By locally tailoring the microstructure and mechanical properties of certain structural components such that they comprise regions with very high strength (very hard), i.e. high ultimate tensile strength and high yield strength and regions with increased ductility (softer), i.e. lower ultimate tensile strength and lower yield strength and increased elongation before break, it may be possible to improve their overall energy absorption and maintain their structural integrity during a crash situation and also reduce their overall weight. Such soft zones may also advantageously change the kinematic behavior in case of a collapse of a component under an impact.

Known methods of creating regions with increased ductility (“softzones” or “soft zones”) in structural components of vehicles include the provision of tools comprising a pair of complementary upper and lower die units, each of the units having separate die elements (steel blocks). A blank to be hot formed is previously heated to a predetermined temperature e.g. austenization temperature or higher by, for example, a furnace system so as to decrease the strength i.e. to facilitate the hot stamping process.

The die elements may be designed to work at different temperatures, in order to have different cooling rates in different zones of the part being formed during the quenching process, and thereby resulting in different material properties in the final product e.g. soft areas which will generally have a lower ultimate tensile strength and a lower yield strength, but allow for more elongation before breaking. E.g. one die element may be cooled in order to quench the corresponding area of the component being manufactured at high cooling rates and to thereby reduce the temperature of the component rapidly and obtain a hard martensitic microstructure. Another neighboring die element may be heated in order to ensure that the corresponding portion of the component being manufactured cools down at a lower cooling rate, in order to obtain a softer microstructure, including e.g. bainite, ferrite and/or perlite. Such an area of the component may remain at higher temperatures than the rest of the component when it leaves the die.

Other methods for obtaining hot stamped components with areas of different mechanical properties include e.g. tailored or differential heating prior to stamping, and local heat treatments after a stamping process to change the local microstructure and obtain different mechanical properties. Yet further possibilities include the use of patchwork blanks, and Tailor Welded Blanks (TWB) combining different thicknesses and/or materials in blanks.

Several methods of differentiating heating prior to stamping are known. In an example, a nozzle or set of nozzles may discharge a fluid stream, e.g. compressed cooling air, towards a portion of the blank to be cooled e.g. while the bank is still in an oven. Other parts of the blank may be maintained at a higher temperature. This makes it possible to obtain a blank with a tailored temperature profile along its length and/or width. In some examples, the blank may undergo further heating in the oven before being subjected to the stamping process.

In other examples, an array of infrared heaters may be used which may be independently controlled to control temperatures along a blank.

Some elements of the structural skeleton of a car e.g. front and rear rails, seat crossmembers and roof rails may be designed specifically for supporting compression loads. That is, these parts are arranged such that in case of standard collision scenarios they are subjected to compressive loads. These and other structural components may have one or more regions with a substantially U-shaped (also known as “hat”-shaped) cross section. These structural components may be manufactured in a variety of ways and may be made of a variety of materials. Lightweight materials that improve the energy absorption during a crash while also keeping the integrity of the vehicle are desired.

Throughout the present disclosure, a U-shaped cross-section may be understood as relating to a structural member which in a cross-section (generally in a transverse plane which is substantially perpendicular to a longitudinal axis of the structural member) has a bottom wall and two side walls. The U-shaped cross-section is generally known for having a good ratio of moment of inertia to weight. The two side walls may form an obtuse angle with the bottom wall, e.g. between 90° and 135°. The two side walls may include outwardly extending side flanges. The bottom wall and side walls may be substantially straight, but they may also include transitions, curved portions, recesses or protrusions.

In addition to the Ultra High Strength Steels mentioned before, more ductile steels may be used in parts of the structural skeleton requiring energy absorption. Examples of ductile steels include Ductibor® 500, Ductibor ® 1000 and CRL-340LA.

UHSS may exhibit tensile strengths as high as 1500 MPa, or even 2000 MPa or more, particularly after a press hardening operation. Once hardened, a UHSS may have a martensitic microstructure. This microstructure enables an increased maximum tensile and yield strength per weight unit.

Some ductile steels may also be heated and pressed (i.e. used in a hot stamping process), but will not have a martensitic microstructure after the process. As a result, they will have lower tensile and yield strength than UHSS, but they will have a higher elongation at break.

Although ductile steel enables energy absorption by a structural component, controlling and predicting how the structural component may behave during a vehicle crash may not be easy. Also, enhancing energy absorption while maintaining a certain structural integrity of the structural component may not be straightforward.

The present disclosure aims to provide improvements in the control of the deformation of and the energy absorption by a structural component for a vehicle framework when subjected to a load, in particular a compressive load.

### SUMMARY

In a first aspect, a structural component for a vehicle framework is provided. The structural component is at least partially configured for supporting compressive loads. The structural component comprises a main member extending from a load receiving end to an opposite end along a longitudinal direction of the main member. The main member comprises a main soft zone having lower mechanical properties than other zones of the main member. Further, the main soft zone comprises a first portion of substantially constant first mechanical properties, and a second portion of substantially constant second mechanical properties, wherein the first mechanical properties are lower than the second mechanical properties.

The introduction of a main soft zone comprising a first and a second portion, with respective first and second mechanical properties, provides a main member with the capacity to effectively absorb energy during a crash, while controlling the kinematics of deformation. A first portion, with lower mechanical properties than the second portion, may deform first when the structural component is subjected to a compressive load before the second portion and before the remainder of the main member. The main member may enable the absorption of more energy during the compression with high degree of deformation predictability. On the other hand, the remaining main member with higher mechanical properties may provide a limit to the deformation, e.g. preserving the internal space of the vehicle. Thus, safety for a vehicle passenger may be enhanced.

A compressive load may be understood as a load or a component of a load acting substantially parallel to a length of the structural component in such a way as to attempt to shorten the component. Components or regions in frameworks of cars that may be particularly subjected to compressive loads in different collision or impact scenarios include: front rails, rear rails, energy absorbers, roof rails and seat crossmembers. Therefore, the examples disclosed herein may be especially beneficial when used in this type of components.

Throughout the present disclosure, “at least partially configured for supporting compressive loads” may be understood as meaning that a part of a component, or the entire component is expected to absorb mainly compressive loads in case of an impact or crash. I.e. even though other loads may occur as well, the compressive loads are expected to be higher.

Also, throughout the present disclosure, references to the “mechanical properties of a portion” may be understood as the mechanical properties of the material forming said portion. Therefore, unless otherwise stated, comparisons of mechanical properties of portions, components, or others, are directed to the material and not to the geometry, or other particularities, of the same.

Higher mechanical properties may herein be understood as a higher ultimate tensile strength and/or a higher yield strength, whereas lower mechanical properties may be understood as a lower ultimate tensile strength and/or a lower yield strength. Ultimate tensile strength and yield strength are herein regarded as material properties of the material after the manufacturing process. Ultimate tensile strength and yield strength may be determined in standardized tensile strength tests, using e.g. A30, A50 or A80 specimens in a quasi-static load test.

The comparison between lower and higher mechanical properties should be made using the same test conditions and specimen size. To compare yield strengths of different portions, specimens formed with the same materials as portions of the structural component, e.g. portions of soft zone(s), may be prepared and tested in a Universal Testing Machine (UTM).

Throughout the present disclosure, a “portion with substantially constant mechanical properties” may be regarded as a portion made of the same material that has been subjected to the same heat treatment. The resulting mechanical properties may be substantially the same with the usual production tolerances. In examples, each portion may have an average magnitude for a mechanical property (such as hardness, yield strength or ultimate tensile strength), and local magnitudes within ±15 % deviation from the average magnitude.

In examples, the main softzone of the structural component is formed by submitting the main soft zone to a different temperature treatment than the other zones of the main member.

In some examples, the main softzone of the structural component may further comprise a third portion of substantially constant third mechanical properties. The third mechanical properties may be higher than the second mechanical properties. Additionally, the main soft zone may comprise more than three portions arranged adjacent one to the other.

In examples, the portions of the main softzone may be arranged along the longitudinal direction based on their mechanical properties, i.e. the portion with lower mechanical properties may be located closest to the load receiving end and the portion with higher mechanical properties may be located farther from the load receiving end. This may result in a structural component that can effectively absorb energy during a crash, while controlling the kinematics of deformation and preserving the internal space of the vehicle. The first portion, with lower mechanical properties than the second portion, may deform first when the structural component is subjected to a compressive load before the second portion and before the remainder of the main member.

In other examples, the portions of the main softzone may be arranged along the longitudinal directions with the portion with higher mechanical properties located closest to the load receiving end and the portion with lower mechanical properties located farther from the load receiving end. Further, the portions of the main softzone may be arranged along the longitudinal direction based on other parameters or considerations.

In examples, the main softzone may be configured over the whole width (or whole cross-section) of the main member of the structural member. In other examples, the main softzone may not cover the whole width of the main member. For example, in case of a U-shaped cross-section, the main soft zone may extend from one side flange to the opposite side flange, or may only cover the side walls and bottom, or only part of the side walls and bottom of the U-shape.

In examples, the structural component may comprise a secondary soft zone spaced apart from the main soft zone along the longitudinal direction. The secondary soft zone may be different from the main soft zone. For example, the secondary soft zone may comprise more, or less, portions with different mechanical properties than the main soft zone, and the arrangement of portions within this softzone may be based on other parameters or considerations.

In some examples, the main member of the structural component outside the soft zone(s) has an ultimate tensile strength of predominantly 1.000 Mpa o more, specifically 1.200 MPa or more, and more specifically 1.500 Mpa or more.

In examples, the main member defines a substantially U-shaped cross-section comprising a bottom wall, a first side wall and a second side wall. Additionally, the main member may comprise flanges extending outwardly from the side walls.

In some examples, a width of a transition zone between portions of the soft zone(s), i.e. between the first and second portions of the main soft zone or between the main member and the soft zone(s), may be smaller than 30 mm, specifically between 20 mm and 5 mm. The width of the transition zones may depend on manufacturing parameters such as the difference in temperature between adjacent portions, or on the manufacturing procedure.

Further, in examples, a difference between an average yield strength of two adjacent portions may be greater than 10 %, specifically greater than 15 %, and possibly greater than 20 %.

In some examples, the main member may comprise regions made of hardened, specifically press hardened steel. The main member may comprise regions made of ultra high strength steel (UHSS) with ultimate tensile strength of 1.000 MPa, and specifically 1.500 MPa or more.

Also, the amount of energy absorption along a length of the main member may be tailored in different ways. For example, more energy may be absorbed when an area of a cross-section of the main member increases. Therefore, energy absorption may increase from a first cross-section of the main member closer to where an impact may be received to a cross-section which is farther away.

In some examples, the main member may comprise one or more ribs. The ribs may extend over the bottom wall, or one of the first side wall and the second side wall.

Throughout this disclosure a rib may be understood as an elongated, substantially straight part of a main member for local reinforcement. The ribs may be manufactured during a stamping process. In some examples, the ribs may be formed by using a patchwork blank, i.e. before the stamping process, a patch blank is welded (e.g. spot welded) to the main blank. In other examples, the ribs may be formed as deformations of the same main blank.

The presence of one or more ribs in the main member may help to adjust the deformation behavior of the structural component. The ribs, which are less ductile and more resistant than the main member, may help to create specific bending locations in the structural component. Accordingly, the deformation of the structural component can be optimized. Particularly when the structural component is configured to support compressive loads, the energy absorption can be increased.

The number, position and extension of portions with different mechanical properties that the remainder of the main member, as well as the number, position and extension of ribs in the structural component may be selected according to a desired behavior of the structural component in terms of deformation, e.g. particularly under compressive loads of the main member resulting from a (simulated) impact or crash.

In examples, the structural component may include an additional piece attached to the main member. The additional piece may e.g. be a plate, or cover attached at flanges of the main member. The additional piece may also be similarly sized and shaped as the main member, i.e. the structural component is formed by two similar pieces. In examples, the main member and additional piece may both have a U-shaped or hat-shaped cross-section with outwardly extending flanges. In examples, the flanges may be configured to have lower mechanical properties as well. The first and subsequent portions of the soft zone may extend into the flanges, or the flanges may form yet a different portion of the soft zone, i.e. the flanges may be submitted to a different thermal treatment than the side walls and bottom of the U-shaped cross-section. The flanges may for example have a lower strength and more ductility than the adjoining main soft zone.

In some examples, the soft zone(s) including the aforementioned, first and second (and optionally further) portions may be formed in the additional piece as well.

In a further aspect, a method for manufacturing a structural component at least partially configured for supporting compressive loads in order to obtain a structural component for a vehicle framework as described in this disclosure is provided.

The method comprises providing a main blank. The method further comprises heating the main blank at least partially to above an austenization temperature, wherein adjacent first and second portions are heated differently than other portions of the main blank, and press hardening the heated main blank forming a main member of the structural component. The main member formed comprises a main soft zone having lower mechanical properties than other zones of the main member. Further, the main soft zone comprises the first portion of substantially constant first mechanical properties and the second portion of substantially constant second mechanical properties. Besides, the first mechanical properties are lower than the second mechanical properties.

This method may improve the deformation behavior of a structural component configured for supporting compressive loads and may enable adjusting how the structural component deforms during e.g. a car crash. Thus, energy absorption by the structural component may be enhanced.

A main blank is to be understood herein as a blank, e.g. a metal sheet or flat metal plate that will form the main member. The main blank may be made of hardenable steel, specifically boron steel. A thickness of the main blank may be typically between 1 and 2.5 mm.

In examples of the method, the first portion may be arranged closer to a load receiving end than the second portion.

In some examples of the method, the heating step comprises heating the main blank substantially homogenously above an austenization temperature, and subsequently cooling portions of the main blank, particularly below an austenization temperature.

In some examples of the method, the cooling may comprise blowing air through nozzles against the portions of the main blank to be cooled. The portions to be cooled may extend along a substantially transverse direction of the main blank and/or along a substantially longitudinal direction of the main blank.

This approach to cool specific portion of the main blank may generate precisely defined temperature areas and gradients of temperature along and/or across the main blank. Thus, the cooling effect can be localized, and the mechanical properties of the different portions may be precisely controlled. This allows for predictable and substantially constant mechanical properties within each portion and relatively small transition zones between them.

In some further examples, the cooling may comprise lowering the temperature of the cooled portions 100 degrees with respect to the other portions of the main member, and more specifically 200 degrees with respect to the other portions of the main member.

In some examples, the cooling may be performed using an array of nozzles or a matrix of nozzles. Thus, the nozzles may precisely define a portion of the main member to be cooled.

In examples, the nozzles may propel compressed air with an overpressure of at least 2 bar, specifically 3 bar and more specifically 4 bar. The overpressure should be understood as a difference in pressure between atmospheric pressure at normal conditions and the total pressure of the compressed air, i.e. static pressure plus dynamic pressure.

In some examples, the nozzles may comprise at least one tangential nozzle. The tangential nozzle may propel compressed air with a directional component that is substantially parallel to the processing plane, i.e. the surface of the component. Thus, this tangential nozzle may generate a flow seal, which may prevent the air from the other nozzles to reach a portion of the main blank. Therefore, tangential nozzles may be used to control the gradient of temperature along and/or across the main blank.

In examples, the nozzles may comprise a nozzle configured to generate a negative pressure area at a desired location inside the heating facility. The negative pressure area may be suitable for separating areas of different air temperature.

### BRIEF DESCRIPTION OF THE DRAWINGS

Non-limiting examples of the present disclosure will be described in the following, with reference to the appended figures, in which:

FIG. 1 schematically represents an example of a structural component for a vehicle at least partially configured for supporting compressive loads.

FIG. 2 schematically illustrates two cross-sections of an example of a structural component.

FIG. 3 schematically represents another example of a structural component for a vehicle at least partially configured for supporting compressive loads.

FIG. 4 schematically illustrates the yield strength after quenching of an exemplary main member as a function of longitudinal position.

FIG. 5 schematically represents a further example of a structural component for a vehicle at least partially configured for supporting compressive loads.

FIG. 6 schematically illustrates a cross-section of the structural component of FIG. 5.

FIG. 7 schematically illustrates a further example of a structural component for a vehicle at least partially configured for supporting compressive loads.

FIG. 8 schematically illustrates another example of a structural component for a vehicle at least partially configured for supporting compressive loads.

FIG. 9 schematically illustrates a further example of a structural component for a vehicle at least partially configured for supporting compressive loads.

FIG. 10 is a flow chart of a method for manufacturing a structural component at least partially configured for supporting compressive loads.

The figures refer to example implementations and are only be used as an aid for understanding the claimed subject matter, not for limiting it in any sense.

### DETAILED DESCRIPTION OF EXAMPLES

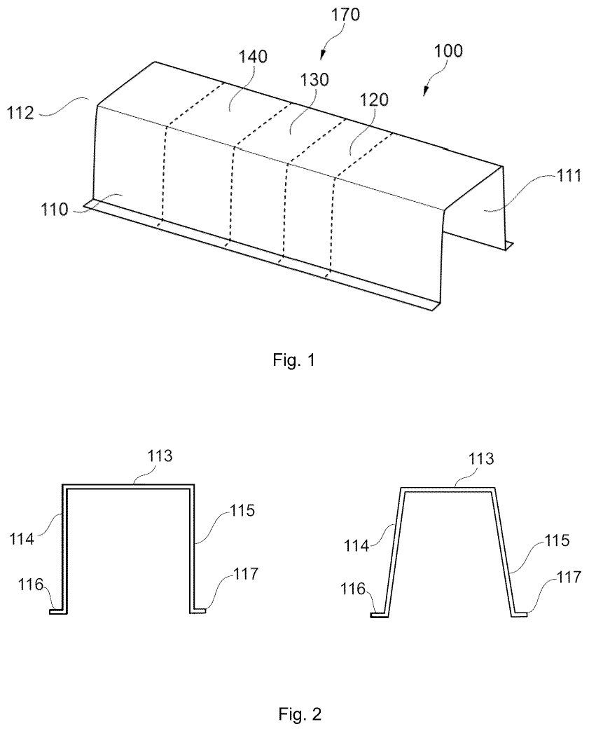

FIG. 1 schematically represents a structural component 100 for a vehicle configured, or at least partially configured, for supporting compressive loads. The structural component 100 comprises a main member 110 extending from a load receiving end 111 to an opposite end 112 along a longitudinal direction of the main member 110. The main member 110 comprises a main soft zone 170 having lower mechanical properties than other zones of the main member. Further, the main soft zone 170 comprises a first portion 120 of substantially constant first mechanical properties, and a second portion 130 of substantially constant second mechanical properties. Further, the first mechanical properties are lower than the second mechanical properties.

In the example illustrated in FIG. 1 the first portion 120 is arranged closer to the load receiving end 111 than the second portion 130, but in other examples the second portion 130 may be arranged closer to the load receiving end 111 than the first portion 120.

As illustrated in FIG. 1, the main soft zone 170 of the main member 110 may further comprise a third portion 140 of substantially constant third mechanical properties. The third portion 140 may be arranged adjacent to the second portion 130. Further, the third mechanical properties may be higher than the second mechanical properties.

Thus, the main member 110 may comprise a main soft zone 170 including two or more distinctive portions 120, 130, 140 in terms of mechanical properties, one adjacent to the other. The portions 120, 130, 140 may be arranged based on the mechanical properties, i.e. the portion with lowest mechanical properties closest to the load receiving end 111. An aspect of this arrangement is that in case of a compressive load (in case of an impact), subsequent portions from the load receiving end have increasing strength and will deform in a controlled manner, i.e. first the portion that is closest to the load receiving end and has the lowest mechanical properties, then the adjacent subsequent portion with higher mechanical properties, and so on.

Alternatively, the portions 120, 130, 140 may be arranged based on other parameters or considerations. Thus, the arrangement of portions 120, 130, 140 may be tailored to adjust the behavior of the structural component 100 when subjected to a compression load.

The main member 110 of the structural component 100 in the example of FIG. 1, outside the main soft zone 170, may have an ultimate tensile strength of predominantly 1.000 Mpa or more, specifically 1.200 MPa or more, and more specifically 1.500 Mpa or more.

The soft zone in an example may have a yield strength of between 300-950 MPa. For example, the soft zone may have a first portion with a yield strength of between 300-500 MPa (e.g. an average around 400 MPa), a second portion with a yield strength of between 400-550 MPa (e.g. an average of around 475 MPa), and a third portion with a yield strength of between 650-800 MPa (average around 725 MPa) and a fourth portion with a yield strength of between 750-950 MPa (e.g. an average around 850 MPa).

Further, the structural component 100 of the example illustrated in FIG. 1 shows that the main member 110 may substantially define a U-shaped or “hat-shaped” cross-section comprising a bottom wall 113, and a first and second side wall 114, 115. The bottom wall 113 may be substantially perpendicular to the first and second side wall 114, 115. In further examples, the bottom wall 113 may define an angle different than 90 degrees with respect to the first and second side wall 114, 115. The structural component 100 may define other cross-section geometries. For example, the structural component 100 may define a L-shaped cross-section, a W-shaped cross-section or others.

Further, the radius of curvature between the bottom wall 113 and the first and second side wall 114, 115 may be adapted according to the specifications of the structural component 100, i.e. mechanical properties of the material used, maximum local strength desired and others.

As illustrated in FIG. 1, the structural component 110 may comprise a first and second flange 116, 117 extending outwardly from the first and second side wall 114, 115 respectively. The flanges 116, 117 provide a convenient attachment point to connect the structural component 100 with other parts of the vehicle, e.g. other components of the structural framework of the vehicle. The radius of curvature between the first and second side wall 114, 115 and the flanges 116, 117 may also vary according to the specifications of the structural component 110, as previously discussed.

In the illustrated example, the main soft zone extends over the whole width of the main member, at least over part of the length of the main member. That is, with the U-shaped cross-section of this example, the main soft zone extends from one side flange to the other side flange. In other examples, the soft zone might extend from one side wall to the other without extending into the flanges. In some cases, secondary soft zones might be created in the flanges e.g. by local softening using a local heat treatment. For example, the areas of connection of the flanges may be softened, i.e. their mechanical properties may be lowered. Such local softening can improve the kinematics in case of an impact and particularly delay or avoid rupture of the joints at the flanges.

In some examples, the main member 110 may be made of a boron steel like Usibor®, e.g. Usibor® 1500 (22MnB5 steel with or without protective coating), Usibor®2000 (37MnB5) or any martensitic steel or ultra high strength steel (UHSS). Usibor®, Ductibor® and 22MnB5 may be commercially available from ArcelorMittal. CRL-340LA is commercially available from SSAB.

Usibor® 1500 is supplied in ferritic-perlitic phase. It is a fine grain structure distributed in a homogenous pattern. Its mechanical properties are related to this structure. After heating, a hot stamping process and subsequent quenching, a martensite microstructure is created. As a result, tensile strength and yield strength increase noticeably.

The composition of Usibor® 1500 is summarized below in weight percentages (the rest is iron (Fe) and impurities):
Maximum carbon (C) (%): 0.25
Maximum silicon (Si) (%): 0.4
Maximum manganese (Mn) (%): 1.4
Maximum phosphorus (P) (%): 0.03
Maximum sulphur(S) (%): 0.01
Aluminium (AI) (%): 0.01-0.1
Maximum titanium (Ti) (%): 0.05
Maximum niobium (Nb) (%): 0.01
Maximum copper (Cu) (%): 0.20
Maximum boron (B) (%): 0.005
Maximum chromium (Cr) (%): 0.35Usibor® 2000 is an example of another boron steel, 37MnB5, with even higher strength. After a hot stamping die quenching process, the yield strength of Usibor® may be 1400 MPa or more, and its ultimate tensile strength may be above 1800 MPa.

The composition of Usibor® 2000 is summarized below in weight percentages (rest is iron (Fe) and impurities):
Maximum carbon (C) (%): 0.36
Maximum silicon (Si) (%): 0.8
Maximum manganese (Mn) (%): 0.8
Maximum phosphorus (P) (%): 0.03
Maximum sulphur(S) (%): 0.01
Aluminium (AI) (%): 0.01-0.06
Maximum titanium (Ti) (%): 0.07
Maximum niobium (Nb) (%): 0.07
Maximum copper (Cu) (%): 0.20
Maximum boron (B) (%): 0.005
Maximum chromium (Cr) (%): 0.50

### Maximum Molybdenum (mb) (%): 0.50

Boron steels, like 22MnB5 or 37MnB5 and others, may be presented with an aluminum-silicon coating in order to avoid decarburization and scale formation during the forming process.

Several 22MnB5 and other boron steels are commercially available having a similar chemical composition. However, the exact amount of each of the components in a 22MnB5 steel may vary slightly from one manufacturer to another. Other ultra high strength steels include e.g. BTR 165, commercially available from Benteler.

FIG. 2 schematically illustrates two cross-sections of an example of a structural component. These and other cross-sections may be part of the same structural component, i.e. the structural component may have a cross-section that changes along the longitudinal direction, or may be cross-sections corresponding to different structural components.

Although not shown in the example of FIG. 2, the bottom wall 113 may be curved or comprise recesses or protrusions along the bottom. This also applies to the side walls 114, 115, which are not necessarily completely straight. The side walls 114, 115 may include straight portions with a curved transition zone between straight portions. In addition, the side walls 114, 115 may or may not be symmetrical. For example, a height of the first side wall 114 may be different from a height of the second side wall 115. In some examples, a height along the longitudinal direction of the first and/or second side walls 114, 115 may also vary. In examples, a width of the bottom wall 113 may be different from a height of the first and/or second side walls 114, 115. Other examples may include any combination of the above examples.

The flanges 116, 117 may be shaped and dimensioned to lie over specific vehicle components and may be used to join the structural component to other components such as other vehicle framework components.

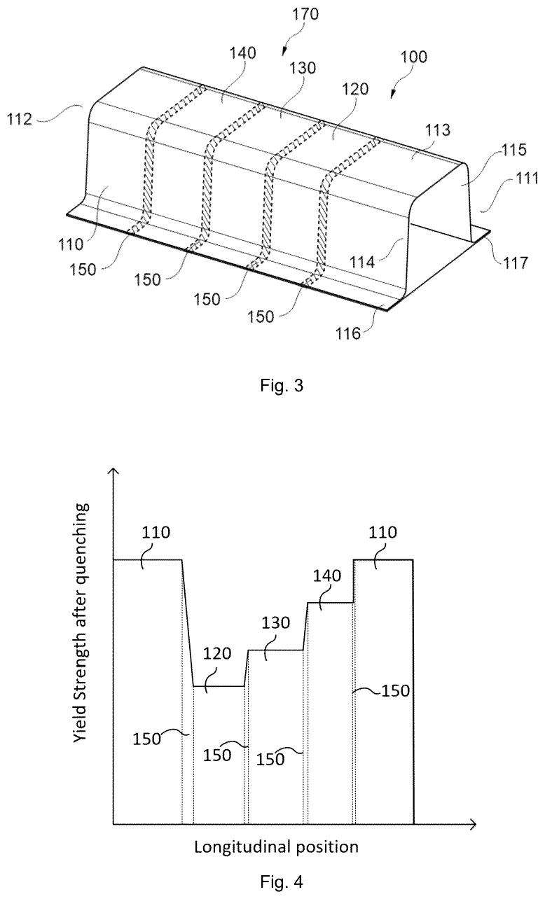

FIG. 3 schematically represents another example of a structural component 100 for a vehicle wherein the structural component is configured, or at least partially configured, for supporting compressive loads. In this example, the main member 110 comprises a main soft zone 170 including three portions 120, 130, 140 that have a lower yield strength and/or ultimate tensile strength, than the remainder of the main member 110. The three portions 120, 130, 140 may be more ductile than the remainding harder parts of the main member. In particular, the three portions may have a higher elongation at break, and/or an increased reduction in area before break.

Further, the three portions 120, 130, 140 have different mechanical properties as they are subjected to different heat treatments. Other numbers of portions, e.g. four or more, as well as other relative sizes may be included in a structural component 100 according to the present disclosure.

In the illustrated example, the local yield strength of each portion 120, 130, 140 may be within ±15 % deviation from an average yield strength of the respective portion. Further, in some examples, the yield strength of each portion 120, 130, 140 may vary less than 10 % within each portion, i.e. the magnitude of the yield strength at a load receiving end of a portion 120 may be substantially constant.

As shown in FIG. 3, the main member 110 may comprise a transition zone 150 between the soft zone 170 and the other zones of the main member with a width of less than 30 mm, specifically between 20 mm and 5 mm. The width of the transition zone 150 may depend on manufacturing parameters such as the difference in temperature between adjacent portions, or on the procedure followed to manufacture the structural component.

The transition zones 150 between adjacent portions 120, 130, 140 of the soft zone 170 may have the same width as previously discussed. Thus, the yield strength in the transition zones 150 may change abruptly, i.e. from a relatively high yield strength at the end of the transition zone 150 adjacent the main member 110 to a relatively low yield strength at the end of the transition zone 150 adjacent to the main soft zone 170.

In the illustrated example, and as can be also seen in FIG. 4, the first portion 120, which is located closest to the load receiving end 111 of the main member 110 is the “softest”, and most ductile portion. Ductility (measured e.g. as elongation at break for given test conditions or reduction of area at break) may be highest in this portion, whereas yield strength and ultimate tensile strength are lower. Further, in some examples, all portions 120, 130, 140 of the main soft zone 170 are arranged along the longitudinal direction ordered by increasing mechanical properties, i.e. from low to high based on the yield strength of the material forming said portions. This has been also illustrated in FIG. 4.

The difference between an average yield strength of two adjacent portions 120-130, 130-140 may be greater than 100 MPa, 150 MPa or 200 MPa. In examples, adjacent portions may have a difference in average yield strength of 10%, specifically greater than 15% and more specifically greater than 20%. In some examples, the difference between average yield strength of two adjacent portions may not be same as the difference between other two adjacent portions. For example, the difference between average yield strength of portions 120, 130 may be 10%, whereas the difference between average yield strength of portions 130, 140 may be 15%.

As in the example of FIG. 1, the main soft zone 170 extends substantially over the whole cross-section or whole width of the main member.

FIG. 4 is a simplified graph illustrating the average yield strength for each cross-section of the structural component of FIG. 3 as a function of the longitudinal position. The horizontal axis represents the longitudinal position along the structural component 100 from the load receiving end 111 to the opposite end 112, i.e. the load receiving end 111 corresponds to the center of coordinates. The vertical axis represents an average cross-section yield strength after the structural component has been quenched, i.e. once it is at room temperature after press hardening.

Note that the reference numerals in FIG. 4 are associated with the features in FIG. 3. Thus, a region of the graph with a given reference numeral is not the feature itself but points to the yield strength of the corresponding feature in FIG. 3.

In the materials typically used when hot stamping the structural component of the present disclosure, yield strength (or tensile strength) and ductility are inversely correlated, i.e. as the microstructure of the material changes and yield strength increases ductility decreases, and vice versa.

Thus, FIG. 4 shows that the yield strength at the load receiving end 111 of the main member 110 is relatively high and nearly constant. Then, before reaching a first portion 120, the yield strength of the main member 110 sharply decreases (and the ductility therefore increases) at the first transition zone 150. This change in mechanical properties occurs in a relatively short width, e.g. of the order of up to 20 or 30 mm. After this first transition zone 150, the main member 110 comprises a first portion 120 of low strength and high ductility. The mechanical properties of this first portion 120 do not change significantly along the longitudinal direction, since the heat treatment is in principle homogeneous for the first portion 120.

The local yield strength of the main member is higher at a second transition zone 150 after the first portion 120. The second plateau after the second transition zone 150 corresponds to the second portion 130; and the same occurs between the second and third portion 130, 140 and between the third portion 140 and the remainder of the main member 110, i.e. the opposite end 112. As can be seen in FIG. 4, the yield strength gradient in different transition zones 150 may be different.

Note that FIG. 4 does not include strength and longitude magnitudes since it serves as a mere example for the present disclosure. Also, the width of some of the transition zones may appear to be relatively large compared to the length of the portions of the main soft zone, but this has been done explicitly to illustrate potential differences in yield strength gradients. The microstructure that may be obtained can be controlled through appropriate temperature treatments.

As previously discussed, the portions 120, 130, 140 may be arranged along the longitudinal direction based on other parameters or considerations. Further, the portions 120, 130, 140 do not necessarily have to be located between areas of high mechanical properties, i.e. a portion may be located at an end of the structural component 100.

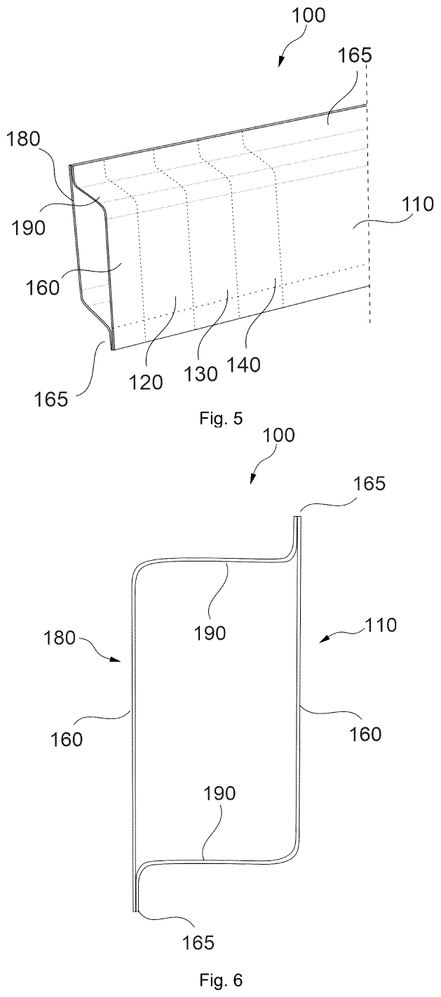

FIG. 5 schematically represents a further example of a structural component 100 for a vehicle wherein the structural component is configured, or at least partially configured, for supporting compressive loads. In this example, the structural component 100 may be a front or rear rail of the vehicle.

In this example, the main member 110 comprises a main soft zone 170 with three portions 120, 130, 140 that have a lower yield strength, and/or ultimate tensile strength, than the remainder of the main member 110. The three portions 120, 130, 140 may be more ductile than the remaining harder parts of the main member. In particular, the three portions 120, 130, 140 may have a higher elongation at break, and/or an increased reduction in area before break. Note that the three portions 120, 130, 140 in FIG. 5 have been schematically illustrated with broken lines and that the transition regions between portions have not been illustrated.

Further, and as described in the examples above, the three portions 120, 130, 140 have different mechanical properties. Other numbers of portions, e.g. four or more, as well as other relative sizes may be included in a structural component 100 according to the present disclosure.

In this example, the structural component comprises an additional piece 180 attached to the main member 110. The additional piece 180 may be similarly sized and shaped as the main member 110, i.e. the structural component 100 may be formed by two similar pieces 110, 180. Further, the additional piece 180 may also comprise portions with lower yield strength at the same locations as the main member 110. More precisely, the main member 110 and the additional piece 180 may have substantially the same mechanical properties along their length. I.e. in this example, the structural member is substantially symmetric in terms of mechanical properties.

Further, in the example illustrated in FIG. 5, the main member 110 and the additional piece 180 have a substantially L-shaped cross-section. The L-shaped cross-sections each comprise a lateral wall 160 and a horizontal wall 190. The horizontal wall 190 further comprises a flange 165 extending outwardly.

As illustrated in FIG. 5, the flange 165 may be configured to contact the lateral wall 160 of the other piece, i.e. the flange 165 of the main member 110 may be configured to contact the lateral wall 160 of the additional piece 180, and vice versa. The main member 110 and additional piece 180 may be joined at the flanges. Thus, the main member 110 and the additional piece 180 together define a substantially rectangular closed section.

Additionally, the flange(s) 165 and the portion of the lateral wall(s) 160 configured to be in contact with the same may be made from a material with lower mechanical properties than the portions 120, 130, 140 of the main member 110 and of the additional piece 180. For example, the most ductile portion (e.g. portion 120) of the main member 110 and of the additional piece 180 may have an average yield strength of about 600 MPa or more, and the flanges 165 and corresponding portions of the lateral walls 160 may have a yield strength of about 550 MPa or less. Providing softer flanges can increase the toughness of the joints, e.g. spot welds, between the main member 110 and the additional piece 180 in case of an impact. At the same time, it enhances the overall dynamic response of the component 100 and allows a better control of the deformations.

FIG. 6 schematically illustrates a cross-section of the structural component 100 of FIG. 5.

As previously discussed, the main member 110 and the additional piece 180 may be attached at their flanges 165, defining a substantially rectangular closed cross-section.

In some examples, the geometry of the components may be different, e. g they may define a substantially squared-shaped closed section, the radius of curvature of the components may be different, etc.

In other examples, the main member 110 and the additional piece 180 may not have the same geometry, e.g. the main member 110 may have a substantially U-shaped cross-section and the additional piece 180 may be a substantially flat plate closing the U-shaped cross-section. Also in these cases, a specific heat treatment different from other parts of the main soft zone, may be provided for the flanges.

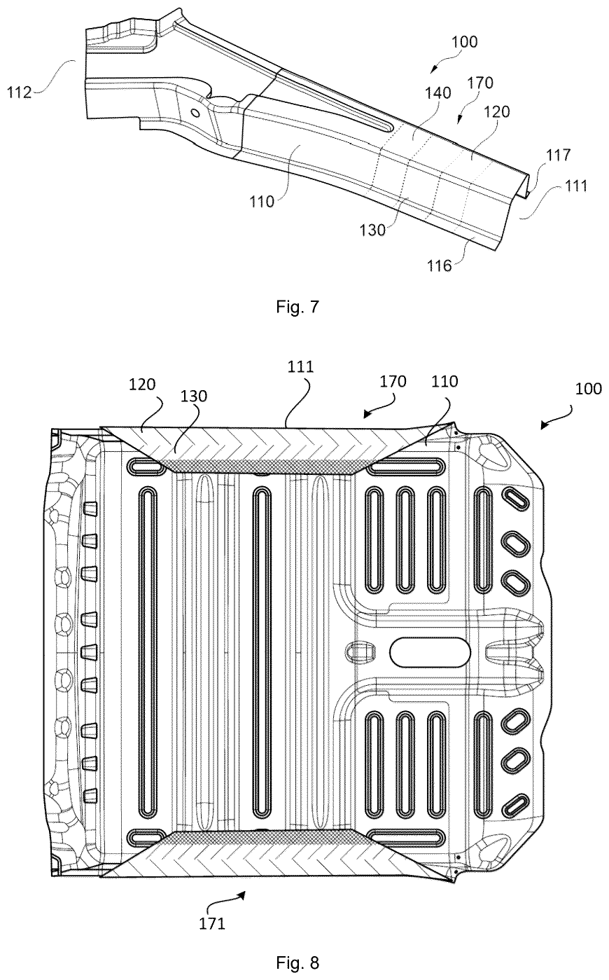

FIG. 7 schematically illustrates a further example of a structural component 100 for a vehicle, wherein the structural component 100 is at least partially configured for supporting compressive loads. In this example, the structural component 100 is a front rail, but other vehicle components such as a door ring, a rear rail, a rear frame, a rocker, a one-piece floor, a crossmember, a front upper rail, and a chassis extension among others may be also illustrative for the present disclosure.

In FIG. 7, a compression impact may be received in the main member 110 at the right side. In this case, the right side of the FIG. 7 would be the load receiving end 111.

Due to the introduction of portions 120, 130, 140 that have lower mechanical properties, i.e. lower tensile strength, than the remainder of the main member 110, deformation of the main member 110 may start close to where the impact takes place instead of in any other region. Note that the transition zones 150 illustrated in FIGS. 3 and 4 have not been illustrated in this figure for reasons of simplicity.

Varying the mechanical properties of the portions may facilitate controlling the deformation of the main member 110, and in particular where the deformation begins. Thus, when a first portion 120 with lowest mechanical properties is located closest to the point where the compression impact is received, the main member will start deforming from this region.

Although not shown in FIG. 7, the structural component 100 may further comprise a secondary soft zone spaced from the main soft zone 170 along the longitudinal direction. For example, a secondary soft zone with higher mechanical properties than the main soft zone 170 may be located farther from the load receiving end 111 to promote a second deformation point.

In some examples, ribs may be included in the main member 110 to further enhance the difference in strength between portions of the main member 110. In fact, features of the ribs including its number, shape, size, location and extension over the main member 110 may be tailored to adjust the behavior of the structural component 100 when subjected to a compression load. The ribs create harder and stiffer areas in the structural component 100. This way, the behavior of the main member 110 and the structural component 100 may be better controlled in a collision.

FIG. 8 schematically represents another example of a structural component 100 for a vehicle framework, wherein the structural component is at least partially configured for supporting compressive loads. In this example, the structural component 100 is a floor of the vehicle. In this particular example, the floor is a one-piece floor formed a single integrally formed component incorporating e.g. the seat cross-beams and the tunnel. The one-piece floor may be formed in a single press hardening process.

In FIG. 8, the vehicle driving direction is from left to right. The longitudinal direction of the floor, in the sense of the independent claims, is vertical in FIG. 8. The floor in this example has been designed and manufactured with a softer zone that is designed to absorb energy in the case of a lateral impact, i.e. from the top or from the bottom in the example of FIG. 8.

The floor in this example comprises a main soft zone 170 with two portions 120, 130 that have lower yield strength and/or ultimate tensile strength than the remainder of the main member 110. In particular, as may be seen in the example of FIG. 8, the main member 110 comprises a main soft zone 170 located at a first side of the main member 110 and a secondary soft zone 171 located at a second side of the main member 110.

The two portions 120, 130 of each of the main and secondary soft zones 170, 171 are configured to be more ductile than the remaining harder parts of the main member 110. In particular, the two portions 120, 130 may have a higher elongation at break, and/or increased reduction in area before break.

In the example of FIG. 8, the first portion 120 is arranged closer to the load receiving end of the main member 110 than the other portion 130 and may be the “softest” and most ductile portion.

The floor of the vehicle may receive a side impact at the load receiving end 111. Since the first portion 120 with lowest mechanical properties is located closest to where the compression impact is received, the main member 110 may start deforming in the first portion 120 of the main soft zone 170 and subsequent portions from the load receiving end, having increasing strength, will deform in a controlled manner. The floor may effectively absorb the impact energy while controlling the kinematics of deformation and preserving the internal space of the vehicle.

In the example of FIG. 8, the main soft zone is tapered along the longitudinal direction (the direction in which the compression load is received in case of a lateral impact). The main soft zone reduces its width along the longitudinal direction. A balance between high strength (low weight) and energy absorption can herewith be provided. Even if the lateral impact is received more towards the front or more towards the rear of the vehicle, the deformation can be steered towards a more central area of the floor with this arrangement.

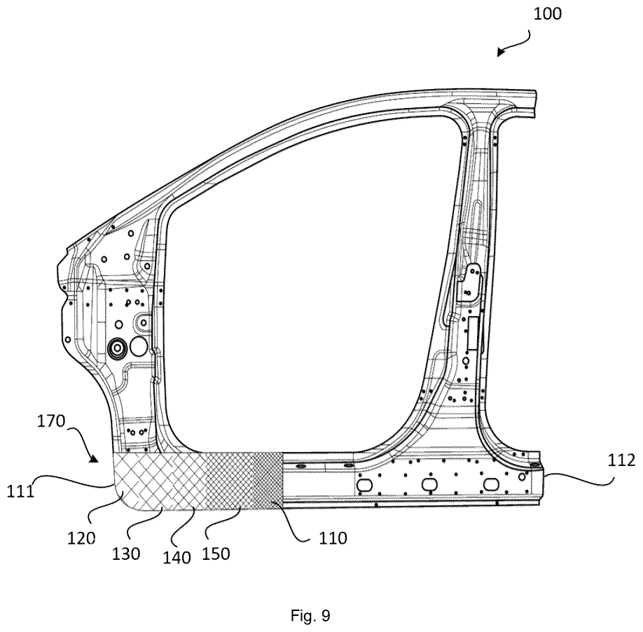

FIG. 9 schematically represents a further example of a structural component 100 for a vehicle framework, wherein the structural component is at least partially configured for supporting compressive loads. In this example, the structural component 100 is a door ring of the vehicle.

As shown in FIG. 9, the door ring in this example extends from the A-pillar and hinge pillar to the B-pillar. The door ring is thus a front door ring. In other examples, the door ring could be a complete door ring extending from A-pillar to C-pillar.

The front door ring in this example includes a B-pillar portion, a rocker portion, a hinge portion and an A-pillar portion. The door ring may be formed by joining different blanks, forming a composite blank and then shaping the composite blank into a one-piece integrally formed door ring.

In this example, the rocker portion of the vehicle, which extends from a load receiving end 111 to an opposite end 112 along a longitudinal direction comprises a soft zone 170.

Further, the door ring, and more particularly, the rocker portion of the door ring comprises a main soft zone 170 with four portions 120, 130, 140, 150 that have lower yield strength and/or ultimate tensile strength than the remainder of the main member 110.

The four portions 120, 130, 140, 150 may be more ductile than the remaining harder parts of the main member 110. In particular, the four portions 120, 130, 140, 150 may have a higher elongation at break, and/or increased reduction in area before break.

In the example of FIG. 9, the four portions 120, 130, 140, 150 of the main soft zone 170 are arranged along a longitudinal direction of the rocker portion of the floor. The first portion 120, which is arranged closer to the load receiving end of the main member 110 than the other portions is the “softest” and most ductile portion. The second portion 130 is adjacent to the first portion 120 and the third portion 140 is adjacent to the second portion 130 and comprises third mechanical properties which are higher than the mechanical properties of the first and second portion 120, 130 but lower than the mechanical properties of the fourth portion 150, which is arranged adjacent to the third portion 140.

In some examples, the yield strength of the first portion 120 may be between 300-600 MPa, specifically between 300-500 MPa and the yield strength of the second portion 130 may be between 350-600 MPa, specifically between 400-550 MPa. Further, the yield strength of the third portion 140 may be between 600-850 MPa, specifically between 650-800 MPa and the yield strength of the fourth portion 150 may be between 700-100 MPa, specifically between 750-950 MPa.

The door ring of the vehicle may receive a front impact at the load receiving end 111. Since the first portion 120 with lowest mechanical properties is located closest to the where the compression impact is received, the main member 110 may start deforming in the first portion 120 of the main soft zone 170 and subsequent portions from the load receiving end, having increasing strength, will deform in a controlled manner. The door ring may effectively absorb the impact energy while controlling the kinematics of deformation and preserving the internal space of the vehicle.

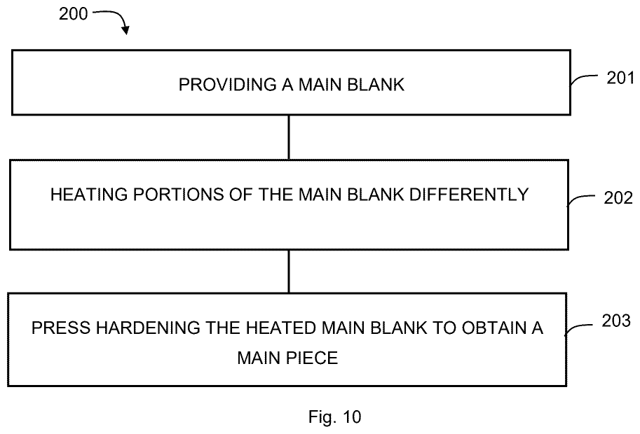

In another aspect of the invention, a method 200 for manufacturing a structural component 100 at least partially configured for supporting compressive loads as described throughout this disclosure, is provided. The method 200 is schematically illustrated in a block diagram in FIG. 10.

The method 200 comprises, at block 201, providing a main blank. The method further comprises, at block 202, heating the main blank at least partially to above an austenization temperature, wherein adjacent first and second portions 120, 130 are heated differently than other portions of the main blank.

Furthermore, the method 200 comprises, at block 203, press hardening the heated main blank forming a main member of the structural component structural component 100. The main member 110 formed comprises a main soft zone 170 having lower mechanical properties than other zones of the main member 110. Further, the main soft zone 170 comprises the first portion 120 of substantially constant first mechanical properties and the second portion 130 of substantially constant second mechanical properties. The first mechanical properties are lower than the second mechanical properties.

Further, the first portion 120 may be arranged closer to a load receiving end 111 than the second portion 130.

In examples wherein the main blank forms a main member 110 configured to be coupled with an additional component 180, the method 200 may comprise heating a portion of the main blank intended to contact the additional component 180 differently than other portions of the main blank (either before, during or after deforming), so that the mechanical properties of this portion after forming are lower than the remainder of the main member 110.

Additionally, the method 200 may be adapted to form a main member 110 with any combination of the technical features previously discussed.

The main blank may be made of any type of hardenable steel, as it has been previously discussed for the structural component 100.

The heating step 202 of method 200 may comprise heating the main blank substantially homogenously above an austenization temperature, and subsequently cooling portions of the main blank particularly below an austenization temperature.

In examples, the main blank may be heated to above Ac3, and portions of the main blank may be cooled to a temperature below Ac3, and even below Ac1 before deforming the blank. The other portions may be maintained above Ac3 until the blank is deformed, or may be cooled temporarily but then heated up again to above Ac3.

For example, during a first phase of the heating step 202 the main blank may be heated substantially homogenously above Ac3 in a main furnace. Then, in a second phase of step 202, a portion of the main blank corresponding to a softzone (after forming) may be cooled to a temperature below Ac3, whereas other parts remain at higher temperature e.g. above Ac3. Additionally, in a third phase of step 202, the main blank may be heated up again maintaining the portion corresponding to a softzone below Ac3 and the remainder of the main blank maintaining a temperature above Ac3. The third phase of step 202 may serve to increase the temperature of the remainder of the main blank above Ac3 in situations wherein the overall temperature of the main blank has decreased during the second phase. The three phases of step 202 may be done in the same furnace or may be done in separate facilities downstream of the main furnace.

In some examples, the heating step 202 of method 200 may comprise blowing air through nozzles against the portions of the main blank to be cooled. The nozzles may be distributed in an array or in a 2D matrix to provide a more precise temperature profile along and/or across the main blank. This may be done in the same furnace where the main blank has been heated or may be done in a separate facility downstream of the main furnace.

The inventors have found that this type of method where a heated blank is partially cooled by means of pressurized nozzles allows to cool specific portions of the blank with a considerable small effect on the temperature of the remaining portions of the blank. This type of method allows to precisely control the temperature profile of the heated main member and the resulting material microstructure along the structural component. Further, this method represents a cost-effective approach to form the structural components of the present disclosure.

The cooling nozzles may set a temperature difference of at least 100 degrees, preferably at least 200 degrees, between at least a first portion 120 of the main member and the remaining of the main member 110. Further, several temperature differences between portions of the main member can be set. For example, it is possible to set three or more portions 120, 130 140 in the main member 110, each with different temperature.

In an example, a part of the blank that is to be fully hardened may remain at a temperature of 900° C. or higher. The first portion may be reduced to a temperature of below Ac1, e.g. between 600 and 700° C. The second portion 120 may have a higher temperature than the first portion but lower than the part of the blank to be fully hardened. The temperature of the second portion may be e.g. between 700 and 800° C.

Thus, the different temperatures can lead to different microstructures or strength properties being set in the respective portions of the main member 110, in particular during any subsequent rapid cooling (“quenching”), such as during a hot stamping process.

In examples, the main member is shaped during the press hardening step 203 to form a component and at the same time is quenched to below 400° C., or specifically below 300° C.

In examples, the cooling nozzles may comprise at least one tangential nozzle. The tangential nozzle may propel compressed air with a directional component that is substantially parallel to the processing plane, i.e. the surface of the component. The tangential nozzle propels compressed at an angle different than zero against the surface of the component. For example, the tangential nozzle may be oriented such that the stream of air from the tangential nozzle and the vector normal to the surface of the component define an angle smaller than 30 degrees, and more specifically smaller than 15 degrees.

Thus, this tangential nozzle may generate a flow seal, which may prevent the air from the other nozzles to reach a given portion of the main blank. Therefore, tangential nozzles may be used to control the gradient of temperature along and/or across the main blank.

In some examples, the cooling nozzles may be mounted on a moving frame that may be able to displace and rotate individual nozzles with respect to the main blank.

Although only a number of examples have been disclosed herein, other alternatives, modifications, uses and/or equivalents thereof are possible. Thus, the scope of the present disclosure should not be limited by particular examples, but should be determined only by a fair reading of the claims that follow.

1. A structural component for a vehicle framework comprising:
a main member extending from a load receiving end to an opposite end along a longitudinal direction of the main member, wherein
the structural component is configured for supporting compressive loads received at the load receiving end, and wherein
the main member comprises a main soft zone, and a transition zone between the soft zone and another zone of the main member, and the entire main soft zone having lower mechanical properties than other zones of the main member, wherein
the main soft zone comprises a first portion of substantially constant first mechanical properties and a second portion of substantially constant second mechanical properties, and wherein the first mechanical properties are lower than the second mechanical properties, wherein
the mechanical properties are ultimate tensile strength and yield strength.

2. The structural component according to claim 1, wherein the first portion is arranged closer to the load receiving end than the second portion.

3. The structural component of claim 1, wherein the main soft zone further comprises a third portion, the third portion having substantially constant third mechanical properties which are higher than the second mechanical properties.

4. The structural component of claim 3, wherein the first portion, the second portion and the third portion of the main soft zone are arranged along the longitudinal direction based on their mechanical properties, with a portion with lower mechanical properties closer to the load receiving end and a portion with higher mechanical properties farther from the load receiving end.

5. The structural component of claim 1, wherein the main soft zone is formed by submitting the main soft zone to a different temperature treatment than the other zones of the main member.

6. The structural component of claim 1, further comprising a secondary soft zone spaced from the main soft zone along the longitudinal direction and closer to the opposite end of the main member.

7. The structural component of claim 6, wherein the secondary soft zone has higher mechanical properties than the main soft zone.

8. The structural component of claim 1, wherein the main member predominantly has an ultimate tensile strength of 1,000 MPa or more.

9. The structural component of claim 1, wherein the main member has flanges having lower mechanical properties than the main soft zone, and the structural component further comprising an additional piece configured to be coupled to the main member at the flanges.

10. The structural component of claim 1, wherein a local yield strength of each of the first and second portions varies less than 15 % about an average yield strength of the first and second portions, respectively.

11. The structural component of claim 10, wherein a difference between an average yield strength of the first portion and of the second portion is greater than 20 %.

12. The structural component of claim 1, wherein the structural component is or forms part of any of a door ring, rear rail, rear frame, rocker, a floor component, a crossmember, a shotgun and a chassis extension.

13. A method for manufacturing a structural component for a vehicle framework, the method comprising:
providing a main blank;
heating the main blank at least partially to above an austenization temperature, wherein adjacent first and second portions of the main blank are heated differently than other portions of the main blank; and
press hardening the heated main blank forming a main member of the structural component, the main member comprising a main soft zone and a transition zone between the soft zone and another zone of the main member, and the entire main soft zone having lower mechanical properties than other zones of the main member, and wherein
the main soft zone comprises the first portion of substantially constant first mechanical properties and the second portion of substantially constant second mechanical properties, and wherein the first mechanical properties are lower than the second mechanical properties, and wherein
the mechanical properties are ultimate tensile strength and yield strength.

14. The method of claim 13, wherein heating the main blank comprises heating the main blank substantially homogenously above an austenization temperature and subsequently cooling portions of the main blank.

15. The method of claim 14, wherein cooling portions of the main blank comprises blowing pressurized air through nozzles against said portions.

16. The method of claim 15, wherein the first portion is cooled down to a temperature between 600 and 700° C., and wherein the second portion is cooled down to a temperature of between 700 and 800° C.

17. The structural component of claim 1, wherein the transition zone has a width of 30 mm or less.

18. A structural component for a vehicle framework comprising:
a main member extending from a load receiving end to an opposite end along a longitudinal direction of the main member, wherein
the structural component is configured for supporting compressive loads received at the load receiving end, and wherein
the main member comprises a main soft zone, and a transition zone between the soft zone and another zone of the main member, and the entire main soft zone having lower mechanical properties than the other zone of the main member, wherein
the main soft zone comprises a first portion of substantially constant first mechanical properties and a second portion of substantially constant second mechanical properties, and wherein the first mechanical properties are lower than the second mechanical properties, wherein
the mechanical properties are ultimate tensile strength and yield strength, wherein
the main soft zone further comprises a third portion, the third portion having substantially constant third mechanical properties which are higher than the second mechanical properties, and wherein
the first portion, the second portion and the third portion of the main soft zone are arranged along the longitudinal direction based on their mechanical properties, with a portion with lower mechanical properties closer to the load receiving end and a portion with higher mechanical properties farther from the load receiving end.

19. The structural component of claim 18, wherein a difference between an average yield strength of the first and of the second portion is greater than 100 MPa, and wherein a difference between an average yield strength of the second portion and of the third portion is greater than 100 MPa.

20. The structural component of claim 18, wherein a yield strength of the first portion is between 300-500 MPa and a yield strength of the second portion is between 400-550 MPa, and wherein a yield strength of the third portion is between 600-850 MPa.
